(19) United States
(12) Patent Application Publication
(10) Pub. No.: US 2004/0147321 A1
(43) Pub. Date: Jul. 29, 2004

(54) Auxiliary games of a lottery-type format and method of play

(75) Inventor: Gerald Duhamel, Drummondville (CA)

Correspondence Address: LABTRONIX CONCEPT INC., C/O OGILVY RENAULT, 1981 MC GILL COLLEGE AVENUE, SUITE 1600, MONTREAL, QUEBEC, H3A 2Y3, CA

(73) Assignee: LABTRONIX CONCEPT INC.

(21) Appl. No.: 10/686,532

(22) Filed: Oct. 16, 2003

Related U.S. Application Data
(60) Provisional application No. 60/418,369, filed on Oct. 16, 2002.
(60) Provisional application No. 60/494,572, filed on Aug. 13, 2003.

(51) Int. Cl. A63F 13/00

(52) U.S. Cl. 463/42

(57) ABSTRACT

The invention consists in a gaming method for the play of a game related to the standard “Double-Up” game in a lottery-type format. According to the invention, a different selection of a “Double-Up” game is completed based on the win value obtained in the primary game. The method comprises steps of: a) a player placing a wager; b) said player playing a round of said primary game to its outcome; c) said outcome being evaluated in order to determine a primary-game value; d) in the case of a non-null primary-game value, providing said player an option of playing an auxiliary game of a lottery type, wherein determination of said auxiliary game depends on the primary-game win value; e) in the case of a positive response of said player to the play of said auxiliary game, providing an auxiliary-game record to said player in exchange for said primary-game win value; and f) revealing information of said auxiliary-game record to determine its value, wherein auxiliary-game record may have either a null value or a doubled value according to said primary-game win value.

### CROSS-REFERENCE TO RELATED APPLICATIONS

This application claims priority of U.S. Provisional Patent Application serial No. 60/418,369, filed on Oct. 16, 2002 and entitled “Method of Generating and Distributing a Population of Lottery Tickets” and of U.S. Provisional Patent Application No. 60/494,572, filed on Aug. 13, 2003 and entitled “Auxiliary Games of a Lottery-Type Format and Method of Play”. The entire content of said provisional applications is incorporated herein by reference.

### FIELD OF THE INVENTION

The invention is a method and a system for playing an auxiliary game of a lottery type depending on the outcome value of a primary game.

### BACKGROUND OF THE INVENTION

Electronic lottery games, such as electronic pull tabs, are very popular nowadays. They have the advantage of providing a game where no trick is available to modify the outcome of the game, therefore ensuring a fair game. According to operators, electronic lottery games have many other advantages, such as providing a fast-playing game; a game that is easy to audit; a game allowing them to pay less taxes on revenues since it is in a different category than other wagering games, and a game that can be more similar to casino games than a paper-based lottery game, therefore a more inciting game.

As used in this disclosure, a lottery-type game is defined as a game using a finite population of records divided in a predetermined number of losing and winning outcomes of predetermined values. For instance, scratch-off or electronic pull-tabs usually fulfill these requirements.

Currently, many organizations, such as non-profit organizations and Native American organizations, are searching for methods and games using a lottery-type format to decrease their taxes. Furthermore, the sought-after games have to provide the entertainment players desire, such as what is offered by casino games.

In order to fulfill players' needs, some game developers have found new ways to distribute lottery tickets (such as in an electronic format instead of in a paper-based format), to provide a more exciting representation of the game to players, or even to provide interaction within a lottery-type game.

Beside all these developments, there is a need for improvement such as a double-up feature in the field of the invention.

### OBJECTS OF THE INVENTION

Accordingly, one object of the invention is to provide an optional auxiliary game in a lottery-type format that fulfills the lottery-type game characteristics. Furthermore, the auxiliary game must provide the same incentive as a standard “Double-Up”.

Another object is to provide this game through a seamless process; therefore the player does not see any difference between a standard “Double-Up” and the current game.

Another object is to provide this game in association with a plurality of games, regardless of the format of the primary game providing a win value.

Yet, another object is to provide interaction with players regarding their choice of whether or not to play the auxiliary game and to make a selection within said game to determine its outcome.

Another object is to provide alternative formats or play processes, which can be selected by players when they decide whether or not to play the auxiliary game.

### SUMMARY OF THE INVENTION

According to these objects, the invention is the use of a plurality of auxiliary games of different reference values with each said auxiliary game comprising a plurality of records.

The reference value of each auxiliary game determines the win value required to play one ticket of the auxiliary game. In consequence, the invention provides a solution that fulfills the game classification the inventor seeks. Furthermore, the sum of the win values of all records of one auxiliary game divided by the sum of their reference values may equal one hundred percent (100%).

The game follows these:

a player placing a bet and playing a primary game to its final outcome;

the outcome being evaluated to determine a win value;

in the case of a non-null value, the player being offered to play a “Double-Up” game;

in the case of a player's positive response, displaying a representation of the “Double-Up” game on the player terminal;

the player selecting his choice within the “Double-Up” game, usually among one of the following possibilities: High or Low, Black or Red, Head or Tail;

the terminal requesting and receiving a record from the auxiliary game of a corresponding reference value, which reference value is the win value in the primary game;

based on the auxiliary-game record information (either a win or a loss), generating a corresponding auxiliary-game outcome representation; and

awarding the win value of the auxiliary game to the player.

The game process may continue in response to a win in the auxiliary game via using the optional win value as a new primary-game win value. Accordingly, the player may play a new round of the “Double-Up” games based on a single primary-game win value.

One alternative embodiment allows the auxiliary-game win values to differ from the double of the reference value. Another one allows the player to stake (or to place a betting amount that correspond to,—what refers to the same action—) only part of his primary-game win value, therefore the reference value determining the auxiliary game is the stake value instead of the primary-game win value.

The preferred system for the play of this auxiliary game is a central distribution system distributing auxiliary-game records to player terminals upon request. When the primary-game win value corresponds to the reference value of one auxiliary game, a “Double-Up” control is available to trigger its play. When no auxiliary game is available, the “Double-Up” control is disabled. Furthermore, as the player's stake selection changes, the “Double-Up” control switches its availability status and the availability of an auxiliary game corresponding to this reference value.

### BRIEF DESCRIPTION OF THE DRAWINGS

These and other aspects and advantages of the present invention will become easier to understand in light of the following detailed description of preferred embodiments with reference to the accompanying drawings, in which:

FIG. 1 is a schematic representation of a system according to the preferred embodiment;

FIG. 2 is a schematic illustration of record correspondence between the primary and the auxiliary game;

FIG. 3 is a flow chart that illustrates the process of playing a primary game and an auxiliary game; and

FIG. 4 is a flow chart that illustrates the additional steps related to a player's stake selection.

### DETAILED DESCRIPTION OF THE PREFERRED EMBODIMENTS

For description purposes, the following embodiment uses a lottery-type game as the primary game. However, any game fulfilling the Class II requirements may be used as long as it is played through a player terminal. Furthermore, this embodiment involves a single primary game concurrently available to a plurality of players on a network of player terminals. The number of primary games could increase without departing from the scope of the invention.

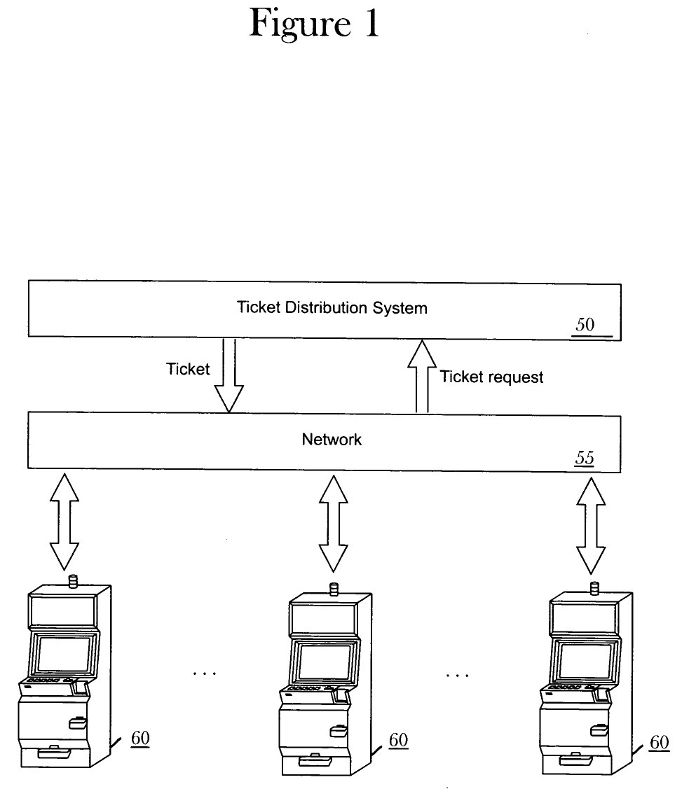

FIG. 1 illustrates a suitable system for the play of the current game. This system includes a plurality of player terminals 60, each one comprising a communication means; a display; a processing system; players' controls allowing players to input commands into the player terminal, which results in the modification of the play, such as ending the play of the game; and a credit control means used to monitor players' credits as they are inserted, wagered and won. The credit control means is frequently embodied in a card reader and/or a player account managed by at least one of the player terminal or a central processing means. Furthermore, the system includes a ticket distribution system 50 and a network 55 maintaining communication between all of these components. The ticket distribution system 50 provides game records upon request from a player terminal 60.

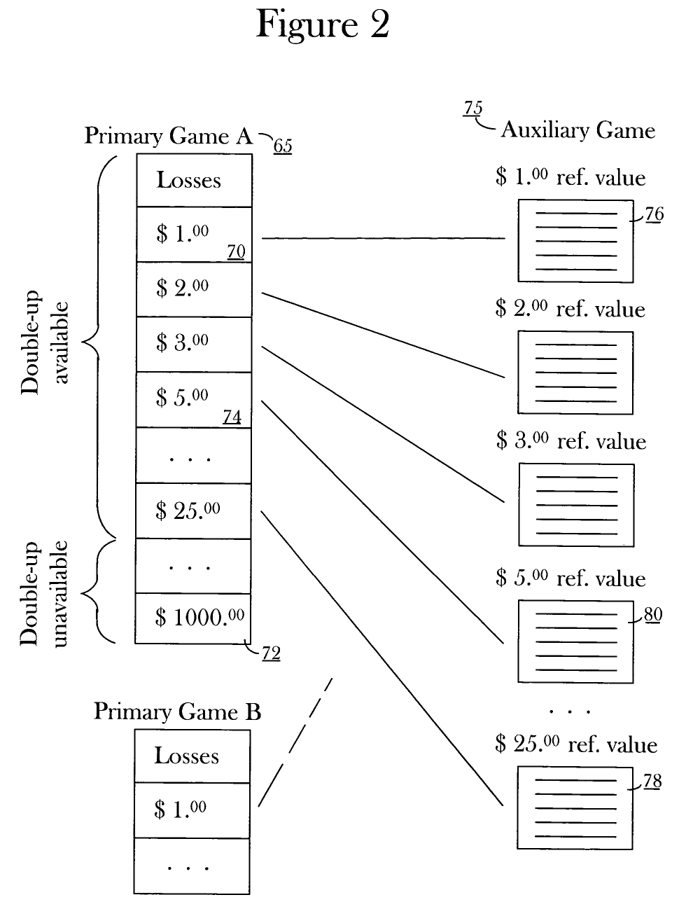

FIG. 2 schematically illustrates the structure of correspondence between a primary game A 65 (also known as an underlying game) and an auxiliary game 75. As embodied, the primary game A 65 provides a variety of available win values varying between $1.00 70 and $1000.00 72. Furthermore, the auxiliary or “Double-Up” game 75 is available for win values varying between $1.00 76 and $25.00 78. Thus, each one of the available win values in that range has a corresponding auxiliary game win value. Thus, if a player obtains a win value of $5.00 74 in the primary game 65, the player will be offered to play the “Double-Up” game 75 with a $5.00 reference value 80 record. However, if the player obtains a win value that lies between $25.00 and $1000.00, no offer for a “Double-Up” game is enabled.

In the preferred embodiment, the number of winning and losing records is the same. The value of the winning records is the double of the reference value. Accordingly, the overall payout percentage of the auxiliary game is one hundred percent (100%). Furthermore, the number of records of a particular value in the primary game does not determine the population size of the auxiliary game since there is no obligation to play the auxiliary game. Furthermore, since a plurality of primary games may allow the playing of the same auxiliary game, no size limitation is present.

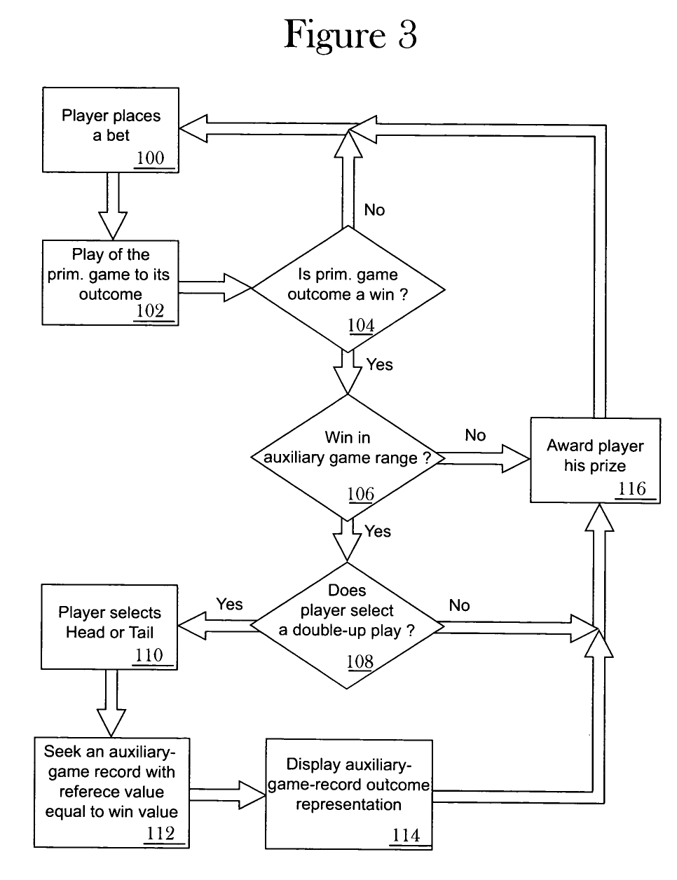

FIG. 3 illustrates through a flow chart the process of playing a primary game and an auxiliary game. At first, a player inserts credits (not shown) in his player terminal. The insertion of credits may be accomplished by means of a coin acceptor, a bill acceptor, a credit card reader, or even the entry of the player identification in the player terminal allowing the player to access his local player account. Once credits are added into the player's account, the player selects a bet level 100 and plays a primary game to its final outcome 102. According to the bet level, the player terminal requests a record for the corresponding game from the distributing means. Record information determines the outcome of the game, which is displayed on the terminal display. The record is either evaluated or simply read to determine a win value. In case of a non-null win value 104 lying between $1.00 and $25.00 106, the player is offered the option to play a “Double-Up” game by means of a graphical interface. The player decides whether or not to play the “Double-Up” and commands the player terminal accordingly 108 by means of the player controls such as electromechanical controls or touch-screen controls. In the case of a negative command, the player is simply awarded his prize 116. In the case of a positive command from the player, a new game representation appears on the screen. For instance, this new representation takes the form of a hand that is about to flip a coin. The player places his stake either on Head or on Tail 110. Once the selection is entered, a record request is sent to the ticket distribution system for an auxiliary-game record. The ticket distribution system takes a record from the auxiliary game with a reference value equal to the player's stake and sends it to the terminal 112. The player terminal analyzes the record information and accordingly selects an outcome representation to display 114. Then, the player is awarded his prize 116, either the double of the stake value or nothing.

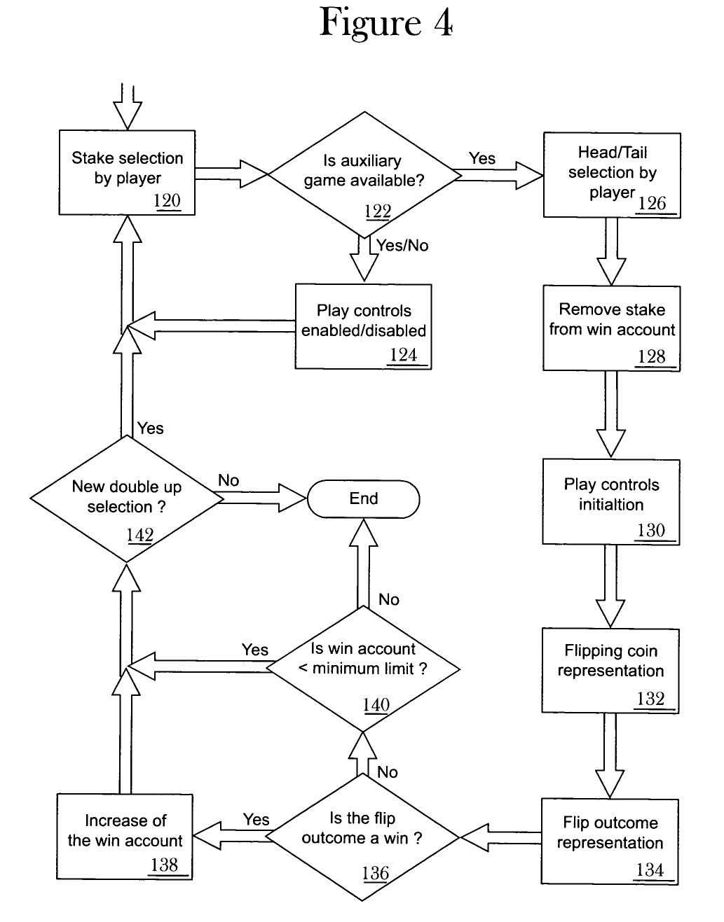

FIG. 4 illustrates the additional steps related to a player's stake selection. Once a player has won, he selects to play the “Double-Up” game. He further selects his stake 120, and the terminal dynamically modifies the availability status of the PLAY control. According to the stake value and the availability of a corresponding auxiliary game 122, the PLAY control is either enabled or disabled 124. Once an available stake is selected, the player selects Head or Tail 126; the stake is redrawn from the player's win account 128; and the double up is initialized 130 and played 132. If the flip outcome corresponds to the player's selection 136, the win account is increased 138 and then player may play again 142. However, in the case of a negative result, the player may only play a new “Double-Up” round 142 if his win account still contains enough credits 140 and the system allows a new play after a failure.

Even though the preferred embodiment discloses an auxiliary game wherein the overall payout percentage is one hundred percent (100%), one can use a game wherein the percentage may differ. For instance, the auxiliary game may generate additional revenues and/or may be associated to bonuses to award to players. According to the last example, players may be provided comps, services, or other awards within the optional auxiliary game.

Furthermore, according to alternative configurations, players may accumulate wins over a plurality of rounds of the principal game before either being offered to play an auxiliary game or answering positively to an auxiliary-game invitation. Thus, it may result in the player placing more than the last win as his stake while playing the auxiliary game.

The same way, the win value may be divided in a plurality of equal-value stakes with each one of these stakes associated win an auxiliary-game record. All of these records are played together, thus, the resulting double-up is a multi-parallel double-up. Consequently, the auxiliary game outcome may result in many values from null values to twice the original win value with a number of intermediary win values depending on the number of subdivided stakes.

Another alternative is the use of a plurality of sub-populations in the auxiliary game. These sub-populations may differ from one another based on their purchase value or other characteristics such as their prize distribution. Using such sub-population provides more flexibility to the auxiliary game through an enhanced possibility of selections.

Other alternatives include variation of the auxiliary-game format; variation of the available win values within the auxiliary game other than double or nothing, such as tie values and odd values; etc.

The primary game format may also vary without departing from the scope of the invention. The primary game may take advantage of the play of a bingo or lotto game as disclosed in the prior art. The auxiliary game representation may vary according to the primary game theme, etc.

Therefore, while the invention has been described in connection with the specific embodiments thereof, it will be understood that it is capable of further modifications. It is the intent of the inventor to cover any variations, uses, or adaptations of the invention following, in general, the principles of the invention and including such departures from the present disclosure as come within known or customary practice within the art to which the invention pertains. These applications will find their essential features herein set forth in the scope of the appended claims.

1. A method of playing an auxiliary game played upon player's request in response to at least one primary-game winning outcome, said method comprising:
providing at least one population of records using divided in a predetermined number of losing and winning outcomes of predetermined values;
receiving at least one win value from said primary game;
receiving from a player a player input to play said auxiliary game;
drawing at least one record from said at least one population of records based on at least one of player's decisions, and win value; and
distributing at least one said record to said player for playing said auxiliary game.

2. The method of claim 1, comprising identifying at least one sub-population of records corresponding to a betting amount among said at least one population based on one of said at least one win value and a sum of said at least one win value.

3. The method of claim 1, further comprising:
withdrawing purchase value of said at least one record from value of said at least one win value; and
awarding said player an outcome value of said at least one record.

4. The method of claim 3, wherein when said purchase value is withdrawn from said win value and leaves sufficient value to permit purchase of a further record from said population, the method further comprises:
receiving from a player a new decision to play said auxiliary game;
drawing at least one new record from said at least one population of records; and
distributing at least one said new record to said player to play said auxiliary game.

5. The method of claim 2, further comprising:
providing said player with a betting amount selection; and
completing said step of population identification based on player's betting amount selection, wherein betting amount selection is available within a range based on said at least one win value.

6. The method of claim 1, wherein at least one of said steps is performed at a player terminal while at least one of said steps is performed at a record distribution system remote from said player terminal.

7. The method of claim 1, wherein said primary game is one using a population of records of predetermined values.

8. The method of claim 7, wherein the payoff percentage of the primary game is lower than the auxiliary-game payoff percentage.

9. The method of claim 8, wherein the auxiliary-game payoff percentage is one hundred percent.

10. A method of playing upon player's request at least one auxiliary game based on auxiliary-game records having a predetermined purchase value and win value, said method comprising steps of:
a) a player placing a wager;
b) said player playing at least one round of said primary game to its outcome;
c) evaluating said at least one outcome in order to determine at least one primary-game outcome value;
d) receiving from said player a player's input to play the auxiliary game;
e) drawing at least one record from said auxiliary-game records based on correlation between said at least one non-null primary-game outcome value and said record purchase value;
f) providing the at least one auxiliary-game record to said player in exchange for a corresponding purchase value;
g) withdrawing said purchase value from said at least one non-null primary-game outcome value;
h) providing the player with at least one auxiliary-game-record representation revealing auxiliary-game-record value; and
i) awarding said player with value of said at least one auxiliary-game record.

11. The method of claim 10, wherein said step d) comprises providing the player with option to select a stake whose value lies within a range based on value of said at least one non-null primary-game outcome.

12. The method of claim 10, wherein when purchase value is withdrawn from said win value and leaves sufficient value to permit purchase of a further auxiliary-game record, the method further comprising:
receiving a new player's input to play a further auxiliary-game play;
drawing at least one new record from said auxiliary-game records; and
completing play based on said new record.

13. A gaming method comprising:
a) providing at least one auxiliary game composed of a plurality of auxiliary-game records divided in a predetermined number of losing and winning outcomes of predetermined values;
b) enabling a player to play an underlying game to its outcome;
c) upon presence of at least one non-null underlying game win value, receiving from said player a player's input to play said auxiliary game; and
d) enabling the player to play said auxiliary game wherein said play involves a correlation between said at least one non-null underlying-game win value and said record purchase-value.

14. The gaming method of claim 13, wherein the payoff percentage of the underlying game is lower than the auxiliary-game payoff percentage.

15. The gaming method of claim 14, wherein the auxiliary-game payoff percentage is one hundred percent.

16. The gaming method of claim 14, wherein winning records of an auxiliary game have a win value that is equal to twice the purchase value of said winning records.

17. The gaming method of claim 13, comprising adding a winning record value to said at least one non-null underlying game win value.

18. The gaming method of claim 17, comprising:
withdrawing from said at least one on-null underlying game win value a record purchase value;
and when it leaves sufficient value to permit purchase of a further auxiliary-game record, the method further comprising:
receiving a new player's input to play a further auxiliary-game play;
drawing at least one new record from said auxiliary-game records; and
completing play based on said new record.

19. The gaming method of claim 13, wherein the play of an auxiliary-game record includes:
providing the player with a option to make a stake selection;
receiving said stake selection from said player; and
enabling said player to play said auxiliary game with record correlation based on said stake selection.

20. The gaming method of claim 19, wherein said stake selection is available within a range based on said at least one non-null underlying-game win value.

21. The gaming method of claim 13, wherein at least one step of said gaming method is performed at a player terminal while at least one of said steps is performed at a record distribution system remote from said player terminal.

22. The gaming method of claim 21, wherein said underlying game and said auxiliary game are played on the same player terminal.

23. The gaming method of claim 13, wherein said underlying game is one using a population of records of predetermined values.

24. The gaming method of claim 13, wherein the payoff percentage of the underlying game is lower than the auxiliary-game payoff percentage.
